(19) United States
(12) Patent Application Publication
(10) Pub. No.: US 2026/0285250 A1
(43) Pub. Date: Sep. 24, 2026

(54) VEHICLE

(71) Applicant: SUBARU CORPORATION, Tokyo (JP)

(72) Inventor: Michifumi OHASHI, Tokyo (JP)

(21) Appl. No.: 19/547,222

(22) Filed: Feb. 23, 2026

(30) Foreign Application Priority Data
Mar. 18, 2025 (JP) 2025-044155

(51) Int. Cl. B60R 21/0134; B60R 21/01

(52) U.S. Cl. CPC B60R 21/0134; B60R 2021/01231

(57) ABSTRACT

A vehicle includes an airbag provided in a vehicle body, an object data obtainer including a radar and a camera, a contact obtainer including a sensor and, and a control apparatus. The object data obtainer performs acquisition of a relative velocity of an object with respect to the vehicle body. The contact obtainer performs acquisition of data indicating that the object and the vehicle body have come into contact with each other. The control apparatus controls the airbag, based on results of the acquisition of the object data obtainer and the contact obtainer. The control apparatus includes one or more processors and one or more memories coupled to the one or more processors. The one or more processors perform activation of the airbag in accordance with the acquisition result of the contact obtainer, and change a condition for the activation of the airbag in accordance with the acquired relative velocity.

### CROSS-REFERENCE TO RELATED APPLICATIONS

The present application claims priority from Japanese Patent Application No. 2025-044155 filed on Mar. 18, 2025, the entire contents of which are hereby incorporated by reference.

### BACKGROUND

The disclosure relates to a vehicle.

In general, a vehicle is provided with a protection device that protects an occupant if an object comes into contact with the vehicle. For example, Japanese Unexamined Patent Application Publication (JP-A) No. 2020-75565 discloses a technique that protects an occupant by deploying an airbag upon side contact in which an object comes into contact with a side of a vehicle. In JP-A No. 2020-75565, a pressure sensor that detects a pressure applied to a door of the vehicle and an acceleration sensor that detects an acceleration rate are provided to detect side contact of the vehicle. In JP-A No. 2020-75565, when a detection value of the pressure sensor is greater than or equal to a threshold value and a detection value of the acceleration sensor is greater than or equal to a threshold value, side contact of the vehicle is detected, and the airbag is deployed.

### SUMMARY

A vehicle includes an airbag, an object data obtainer, a contact obtainer, and a control apparatus. The airbag is provided in a body of the vehicle. The object data obtainer includes a radar and a camera, and is configured to perform acquisition of a relative velocity of an object with respect to the body of the vehicle. The contact obtainer includes a sensor and is configured to perform acquisition of data indicating that the object and the body of the vehicle have come into contact with each other. The control apparatus is configured to control the airbag, based on a result of the acquisition of the object data obtainer and a result of the acquisition of the contact obtainer. The control apparatus includes one or more processors and one or more memories coupled to the one or more processors. The one or more processors are configured to perform activation of the airbag in accordance with the result of the acquisition of the contact obtainer, and change a condition for the activation of the airbag in accordance with the relative velocity acquired by the object data obtainer.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic top view of a vehicle according to a present example embodiment.

FIG. 2 is a schematic configuration diagram of the vehicle illustrated in FIG. 1.

FIG. 3 is a block diagram illustrating an example of a configuration of a control apparatus illustrated in FIG. 2.

FIG. 4 is a block diagram illustrating an example of a configuration of the control apparatus illustrated in FIG. 2.

FIG. 5 is a schematic diagram describing a method of calculating a predicted relative velocity by a calculator illustrated in FIG. 4.

FIG. 6 is a table describing a method of setting a condition for activation of an airbag illustrated in FIG. 2.

### DETAILED DESCRIPTION

If an object comes into contact with a vehicle at a high speed, it is sometimes difficult to reduce an impact applied to an occupant even if an airbag is deployed based on a pressure sensor and an acceleration sensor because the airbag is not fully deployed. What is desired is to set deployment timing of the airbag upon contact of the vehicle to appropriate timing.

It is desirable to provide a vehicle that makes it possible to deploy an airbag at appropriate timing upon contact of the vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

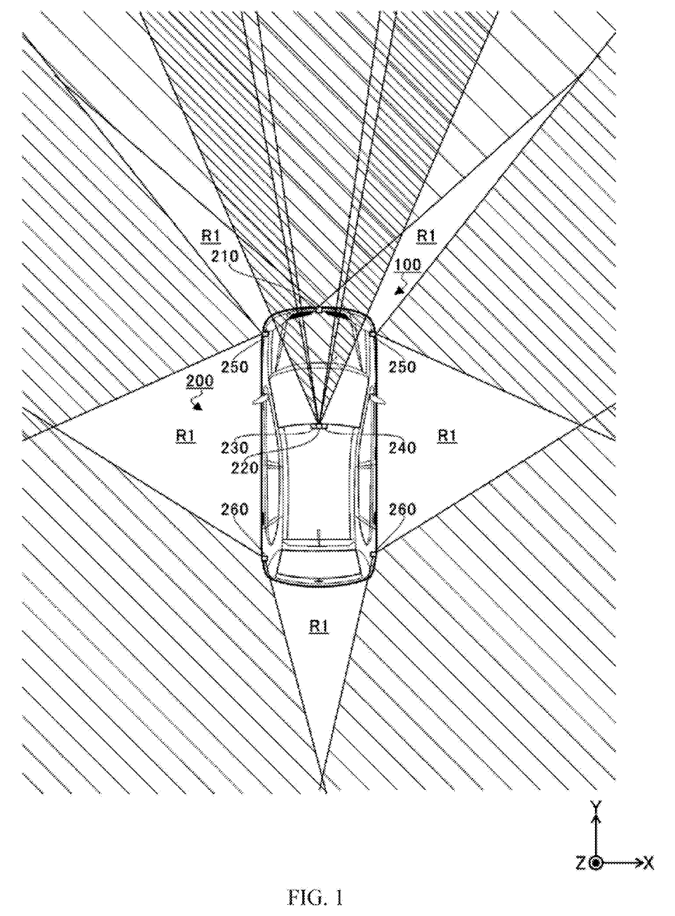

FIG. 1 is a schematic top view of a vehicle 100 according to a present example embodiment. In FIG. 1, a Z direction indicates a vertical direction. For example, a +Z direction is a vertically upward direction, and a −Z direction is a vertically downward direction. In FIG. 1, an X direction indicates a predetermined direction in a horizontal direction, and a Y direction indicates a direction orthogonal to the X direction in the horizontal direction. The Y direction is a front-rear direction of the vehicle 100. For example, a +Y direction is a front direction, and a −Y direction is a rear direction. The X direction is a left-right direction of the vehicle 100. For example, a +X direction is a right direction, and a −X direction is a left direction.

The vehicle 100 may be, for example, a hybrid electric vehicle, which includes two drive sources including an engine and a driving motor. In some embodiments, the vehicle 100 may include, as the drive source, only the engine or only the driving motor. Various types of vehicles such as an engine vehicle and an electric vehicle may be employed as the vehicle 100. Herein, the configuration related to a feature of the present example embodiment will be described in detail, and the description of the configuration irrelevant to the feature of the present example embodiment will be omitted.

As illustrated in FIG. 1, the vehicle 100 includes an object data obtainer 200. The object data obtainer 200 may acquire a relative distance between a body of the vehicle 100 and an object T (see FIG. 5 to be described later). The object data obtainer 200 acquires a relative velocity of the object T with respect to the body of the vehicle 100. The object T may be an object that has a possibility of coming into contact with the vehicle 100 out of objects around the vehicle 100. The object data obtainer 200 may include a front light detection and ranging (LiDAR) 210, a front radar 220, a front camera 230, a driving assistance system 240, a front-side radar 250, and a rear-side radar 260.

The front LiDAR 210 may project a laser beam ahead of the vehicle 100 and receive reflected light of the laser beam. The front LiDAR 210 may detect a distance between the body of the vehicle 100 and the object T and the shape of the object T, based on a time period from when the laser beam is projected to when the reflected light is received. The front LiDAR 210 may be provided, for example, at a front edge of the vehicle 100. A viewing angle of the front LiDAR 210 may sometimes be wider than a viewing angle of the front radar 220.

The front radar 220 may project, for example, a millimeter wave ahead of the vehicle 100 as a transmission wave, and receive a reflected wave of the transmission wave. The front radar 220 may detect the distance between the body of the vehicle 100 and the object T, based on a time difference between a point in time when the transmission wave is projected to a point in time when the reflected wave is received. The front radar 220 may detect an azimuth angle from the body of the vehicle 100 to the object T, based on a projecting direction of the transmission wave. The front radar 220 may be provided, for example, at a front part of an upper portion of the vehicle 100. The viewing angle of the front radar 220 may sometimes be narrower than the viewing angle of the front LiDAR 210.

The front camera 230 may be an imager, and may be, for example, a digital camera using a solid-state imaging device such as a charge-coupled device (CCD) or complementary metal oxide semiconductor (CMOS). The front camera 230 may capture an image of a front environment in a surrounding environment of the vehicle 100. The front camera 230 of the present example embodiment may be a stereo camera, and detect the distance between the body of the vehicle 100 and the object T, based on a parallax of captured images. A viewing angle of the front camera 230 may sometimes be wider than the viewing angle of the front radar 220 and narrower than the viewing angle of the front LiDAR 210.

The driving assistance system 240 may include a stereo camera and a surrounding environment recognition device, capture images of the front environment in the surrounding environment of the vehicle 100 by the stereo camera, and detect the distance between the body of the vehicle 100 and the object T, based on a parallax of the captured images. Further, the object T included in the captured images may be identified by the surrounding environment recognition device. In the present example embodiment, the object T may be, for example, an object such as a vehicle, a person (pedestrian), a traffic signal, a utility pole, or a guardrail. Further, the surrounding environment recognition device may detect the distance between the body of the vehicle 100 and the identified object T and a relative velocity of the object T with respect to the body of the vehicle 100. A viewing angle of the driving assistance system 240 may sometimes be narrower than the viewing angles of the front LiDAR 210 and the front camera 230 and wider than the viewing angle of the front radar 220.

The front-side radar 250 may project, for example, a millimeter wave toward a front-side region of the vehicle 100 as a transmission wave, and receive a reflected wave of the transmission wave. The front-side radar 250 may detect the distance between the body of the vehicle 100 and the object T, based on a time difference between a point in time when the transmission wave is projected to a point in time when the reflected wave is received. The front-side radar 250 may detect an azimuth angle from the body of the vehicle 100 to the object T, based on a projecting direction of the transmission wave.

A pair of front-side radars 250 of the present example embodiment may be provided on front parts of both sides of the vehicle 100 in the left-right direction. The pair of front-side radars 250 may be spaced apart from each other in the left-right direction of the vehicle 100. For example, one of the pair of front-side radars 250 may be provided on the right side of the vehicle 100, and the other may be provided on the left side of the vehicle 100. The right front-side radar 250 may project a transmission wave toward the front right side of the vehicle 100. The left front-side radar 250 may project a transmission wave toward the front left side of the vehicle 100. Viewing angles of the front-side radars 250 may sometimes be narrower than the viewing angle of the front LiDAR 210 and wider than the viewing angles of the front radar 220, the front camera 230, and the driving assistance system 240.

The rear-side radar 260 may project, for example, a millimeter wave toward a rear-side region of the vehicle 100 as a transmission wave, and receive a reflected wave of the transmission wave. The rear-side radar 260 may detect the distance between the body of the vehicle 100 and the object T, based on a time difference between a point in time when the transmission wave is projected and a point in time when the reflected wave is received. The rear-side radar 260 may detect an azimuth angle from the body of the vehicle 100 to the object T, based on a projecting direction of the transmission wave.

A pair of rear-side radars 260 of the present example embodiment may be provided on rear parts of both sides of the vehicle 100 in the left-right direction. The pair of rear-side radars 260 may be spaced apart from each other in the left-right direction of the vehicle 100. For example, one of the pair of rear-side radars 260 may be provided on the right side of the vehicle 100, and the other may be provided on the left side of the vehicle 100. The right rear-side radar 260 may project a transmission wave toward the rear right side of the vehicle 100. The left rear-side radar 260 may project a transmission wave toward the rear left side of the vehicle 100. Viewing angles of the rear-side radars 260 may sometimes be wider than the viewing angles of the front LiDAR 210, the front radar 220, the front camera 230, the driving assistance system 240, and the front-side radars 250.

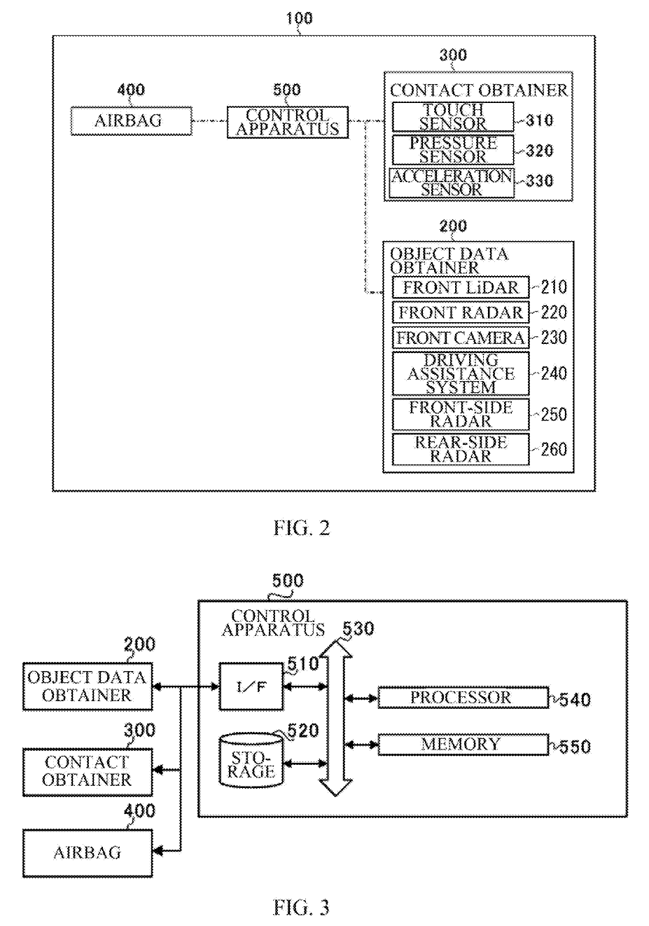

FIG. 2 is a schematic configuration diagram of the vehicle 100 according to the present example embodiment. As illustrated in FIG. 2, the vehicle 100 includes the object data obtainer 200, a contact obtainer 300, an airbag 400, and a control apparatus 500.

The contact obtainer 300 acquires data indicating that the object T and the body of the vehicle 100 have come into contact with each other. In some embodiments, the contact obtainer 300 may include a touch sensor 310, a pressure sensor 320, and an acceleration sensor 330.

The touch sensor 310 may be disposed, for example, on an outer surface of a door on a side of the vehicle 100. The touch sensor 310 may be a contact sensor that detects whether there is any contact on the outer surface of the door. For example, the touch sensor 310 may maintain an OFF state when the object T is not in contact with the outer surface of the door, and shift from the OFF state to an ON state while the object T is in contact with the outer surface of the door. When the touch sensor 310 shifts from the OFF state to the ON state, the touch sensor 310 may output a signal value indicating that the touch sensor 310 is in the ON state to the control apparatus 500 as a detection value.

The pressure sensor 320 may be disposed, for example, inside the door on the side of the vehicle 100. The pressure sensor 320 may detect the pressure inside the door on the side of the vehicle 100. The pressure sensor 320 may output a detected value of the pressure inside the door to the control apparatus 500 as a detection value.

The acceleration sensor 330 may be disposed, for example, inside the door on the side of the vehicle 100. The acceleration sensor 330 may detect an acceleration rate of the body of the vehicle 100. The acceleration sensor 330 may output a detected value of the acceleration rate of the body of the vehicle 100 to the control apparatus 500 as a detection value.

The airbag 400 may serve as a protection device that protects an occupant from an impact of contact. The airbag 400 is provided in the body of the vehicle 100. In the present example embodiment, the airbag 400 may be, for example, a side airbag. If the object T comes into contact with the vehicle 100 from the side, the airbag 400 may be deployed to a space between the door on the side of the vehicle 100 and a seat to protect the occupant from the impact of the contact.

The airbag 400 may include an unillustrated inflator and a bag. The inflator may ignite propellant and generate gas by a chemical reaction caused by combustion. Further, the gas generated by the inflator may be injected into the bag. The bag may be folded compactly when the airbag 400 is not activated. When the gas is injected into the bag by the inflator, the bag may be inflated and deployed. This helps to reduce the impact on the occupant caused due to the contact of the vehicle 100.

The control apparatus 500 may be electrically coupled to and communicable with the object data obtainer 200, the contact obtainer 300, and the airbag 400. The control apparatus 500 controls the airbag 400, based on a result of acquisition of the object data obtainer 200 and a result of acquisition of the contact obtainer 300.

FIG. 3 is a block diagram illustrating an example of a configuration of the control apparatus 500 according to the present example embodiment. The control apparatus 500 may control overall operation of the vehicle 100. In the present example embodiment, the control apparatus 500 controls, for example, the airbag 400. As illustrated in FIG. 3, the control apparatus 500 may include an interface (I/F) 510, a storage 520, a system bus 530. The control apparatus 500 includes one or more processors 540 and one or more memories 550. The I/F 510 may be an interface to be used to communicate with the object data obtainer 200, the contact obtainer 300, and the airbag 400.

The storage 520 may be configured by a storage such as random-access memory (RAM), flash memory, or an HDD, and hold various kinds of data to be used in processing of the one or more processors 540 described below. The system bus 530 may be a transmission path that electrically couples the I/F 510, the storage 520, the one or more processors 540, and the one or more memories 550, and transmit data therebetween.

The one or more processors 540 may each include, for example, a central processing unit (CPU). The one or more memories 550 may each include, for example, read-only memory (ROM) and RAM. The ROM may be a storage device that stores programs, calculation parameters, and other data to be used by the CPU. The RAM may be a storage device that temporarily stores data such as variables and parameters to be used in processing performed by the CPU.

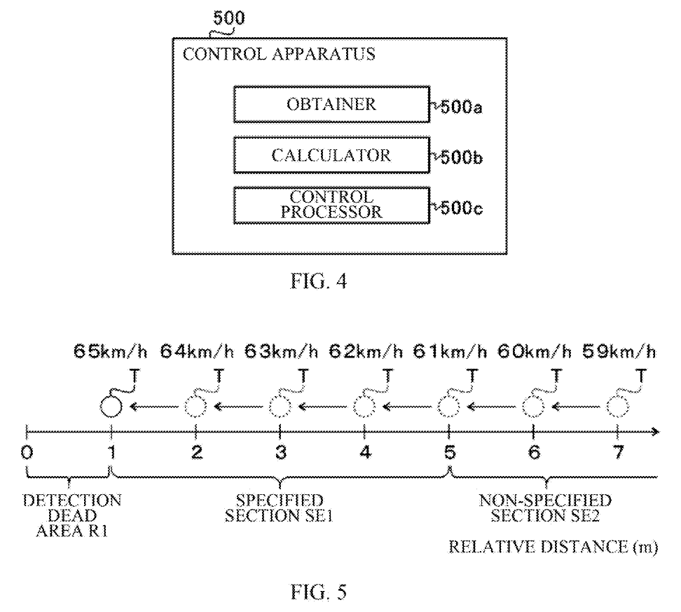

FIG. 4 is a block diagram illustrating an example of a configuration of the control apparatus 500 according to the present example embodiment. For example, as illustrated in FIG. 4, the control apparatus 500 may include an obtainer 500a, a calculator 500b, and a control processor 500c.

The one or more processors 540 may operate in conjunction with the programs held by the one or more memories 550 to execute the programs held by the one or more memories 550. Accordingly, various kinds of processes including processes described below performed by the obtainer 500a, the calculator 500b, and the control processor 500c are executed.

The obtainer 500a may acquire, from the object data obtainer 200, data on a relative velocity of the object T with respect to the body of the vehicle 100. The data on the relative velocity of the object T with respect to the body of the vehicle 100 may include data on the relative distance between the body of the vehicle 100 and the object T and data on the relative velocity of the object T with respect to the body of the vehicle 100.

Further, the obtainer 500a may acquire, from the contact obtainer 300, contact data indicating that the object T and the body of the vehicle 100 have come into contact with each other. The contact data may include, for example, the detection value indicating that the touch sensor 310 is in the ON state, and the detection values of the pressure sensor 320 and the acceleration sensor 330.

The calculator 500b may calculate (predict) the relative velocity of the object T with respect to the body of the vehicle 100 when the object T reaches the body of the vehicle 100, or for example, when the object T is in a detection dead area R1. For example, the calculator 500b may calculate (predict) the relative velocity of the object T with respect to the body of the vehicle 100 when the object T reaches the body of the vehicle 100, based on the relative distance between the body of the vehicle 100 and the object T. Note that, a method of calculating (predicting) the relative velocity by the calculator 500b will be described in detail later with reference to FIG. 5.

The control processor 500c may activate the airbag 400, based on the result of the acquisition of the object data obtainer 200 and the result of the acquisition of the contact obtainer 300. For example, when the detection value detected by the pressure sensor 320 is greater than or equal to a threshold value, the control processor 500c may perform control to activate the inflator of the airbag 400 and deploy the bag. Additionally, when the detection value detected by the acceleration sensor 330 is greater than or equal to a threshold value, the control processor 500c may perform control to activate the inflator of the airbag 400 and deploy the bag. The control processor 500c of the present example embodiment may perform control to activate the inflator of the airbag 400 and deploy the bag when the detection value detected by the pressure sensor 320 is greater than or equal to the threshold value (a first threshold value) or when the detection value detected by the acceleration sensor 330 is greater than or equal to the threshold value (the first threshold value). For example, the control processor 500c may activate the airbag 400, based on one of the detection value of the pressure sensor 320 and the detection value of the acceleration sensor 330. The disclosure is not limited thereto, and in some embodiments, the control processor 500c may activate the airbag 400, based on both of the detection value of the pressure sensor 320 and the detection value of the acceleration sensor 330. For example, in some embodiments, when the detection value detected by the pressure sensor 320 is greater than or equal to the threshold value and the detection value detected by the acceleration sensor 330 is greater than or equal to the threshold value, the control processor 500c may perform control to activate the inflator of the airbag 400 and deploy the bag.

If the object T comes into contact with the door on the side of the vehicle 100, the door may be crushed by the object T. This may cause the pressure inside the door to rise, and the detection value of the pressure sensor 320 disposed inside the door to become greater than or equal to the threshold value. At this time, the control processor 500c may activate the inflator of the airbag 400 to deploy the bag. If the object T comes into contact with the door on the side of the vehicle 100, the door may deform and move in the left-right direction, and the detection value of the acceleration sensor 330 disposed inside the door may become greater than or equal to the threshold value. At this time, the control processor 500c may activate the inflator of the airbag 400 to deploy the bag. Accordingly, the bag of the airbag 400 is deployed to a space between the door of the vehicle 100 and the seat. This helps to protect the occupant from the impact of the contact.

In a case where the object T comes into contact with the vehicle 100 at a high speed, even if the airbag 400 is deployed based on the pressure sensor 320 and the acceleration sensor 330, the airbag 400 may not be fully deployed. It may thus be difficult to reduce an impact applied to the occupant. It is therefore desired to set the deployment timing of the airbag 400 upon contact of the vehicle 100 to appropriate timing.

In order to deploy the airbag 400 at the appropriate timing upon contact of the vehicle 100, the control processor 500c of the present example embodiment changes a condition for activation of the airbag 400 in accordance with the relative velocity acquired by the object data obtainer 200. For example, the control processor 500c may change the condition to cause the timing at which the airbag 400 is activated to become earlier as the relative velocity of the object T with respect to the body of the vehicle 100 increases. The condition for the activation of the airbag 400 will be described in detail below.

The condition for the activation of the airbag 400 is roughly classified into a condition for low-speed contact in which an impact of contact between the body of the vehicle 100 and the object T is relatively small, and a condition for high-speed contact in which an impact of contact between the body of the vehicle 100 and the object T is relatively large. In the present example embodiment, the condition for the activation of the airbag 400 may include a first condition, a second condition, a third condition, and a fourth condition. The condition for the low-speed contact may include, for example, the first condition. The condition for the high-speed contact may include, for example, the second condition, the third condition, and the fourth condition.

The first condition, the second condition, the third condition, and the fourth condition may be different conditions. Because the first condition, the second condition, the third condition, and the fourth condition are different from each other, when the airbag 400 is activated based on each of the conditions, timings at which the activation of the airbag 400 is started may be different from each other. For example, the timing at which the activation of the airbag 400 is started under the first condition may be later than the timings at which the activation of the airbag 400 is started under the second condition, the third condition, and the fourth condition.

Further, the timing at which the activation of the airbag 400 is started under the second condition may be earlier than the timings at which the activation of the airbag 400 is started under the third condition and the fourth condition. Further, the timing at which the activation of the airbag 400 is started under the third condition may be later than the timing at which the activation of the airbag 400 is started under the second condition and earlier than the timing at which the activation of the airbag 400 is started under the fourth condition. Further, the timing at which the activation of the airbag 400 is started under the fourth condition may be later than the timings at which the activation of the airbag 400 is started under the second condition and the third condition.

The first condition may be that the detection value detected by the pressure sensor 320 or the acceleration sensor 330 is greater than or equal to the threshold value (the first threshold value). The first condition may be set by the control processor 500c at a time of low-speed contact in which the relative velocity of the object T with respect to the body of the vehicle 100, for example, a contact speed is higher than or equal to 15 km/h and lower than 65 km/h (a predetermined velocity). Hereinafter, 65 km/h may sometimes be referred to as the predetermined velocity. The threshold value for the detection value in the first condition may sometimes be referred to as a normal sensing value.

As illustrated in FIG. 1, the detection dead area R1 may be present adjacent to the vehicle 100. In the detection dead area R1, it may be difficult to perform detection by the front LiDAR 210, the front radar 220, the front camera 230, the driving assistance system 240, the front-side radars 250, or the rear-side radars 260. When the object T is positioned in the detection dead area R1, it may be difficult to detect the relative velocity of the object T with respect to the body of the vehicle 100.

The calculator 500b of the present example embodiment may therefore predict the relative velocity of the object T positioned in the detection dead area R1 with respect to the body of the vehicle 100. Hereinafter, the relative velocity of the object T predicted by the calculator 500b may sometimes be referred to as a predicted relative velocity.

FIG. 5 is a schematic diagram describing a method of calculating the predicted relative velocity by the calculator 500b according to the present example embodiment. In FIG. 5, a horizontal axis represents the relative distance between the body of the vehicle 100 and the object T. Additionally, FIG. 5 illustrates a state in which the relative distance between the object T and the body of the vehicle 100 decreases with time, and the object T and the body of the vehicle 100 are located at positions where the relative distance is 1 m. Further, FIG. 5 illustrates the relative velocity of the object T at each of the relative distances.

In the example illustrated in FIG. 5, a section in which the relative distance between the body of the vehicle 100 and the object T is greater than or equal to "0 m" to less than "1 m" may be referred to as the "detection dead area R1". A section in which the relative distance between the body of the vehicle 100 and the object T is greater than or equal to "1 m" and less than or equal to "5 m" may be referred to as a "specified section SE1". A section in which the relative distance between the body of the vehicle 100 and the object T is greater than "5 m" may be referred to as a "non-specified section SE2".

In the example illustrated in FIG. 5, it may be assumed that the relative velocity of the object T when the relative distance between the body of the vehicle 100 and the object T is "7 m" is "59 km/h". It may be assumed that the relative velocity of the object T when the relative distance between the body of the vehicle 100 and the object T is "6 m" is "60 km/h". It may be assumed that the relative velocity of the object T when the relative distance between the body of the vehicle 100 and the object T is "5 m" is "61 km/h". It may be assumed that the relative velocity of the object T when the relative distance between the body of the vehicle 100 and the object T is "4 m" is "62 km/h". It may be assumed that the relative velocity of the object T when the relative distance between the body of the vehicle 100 and the object T is "3 m" is "63 km/h". It may be assumed that the relative velocity of the object T when the relative distance between the body of the vehicle 100 and the object T is "2 m" is "64 km/h". It may be assumed that the relative velocity of the object T when the relative distance between the body of the vehicle 100 and the object T is "1 m" is "65 km/h".

The calculator 500b may calculate the predicted relative velocity of the object T in the detection dead area R1, based on the relative velocity of the object T positioned in the specified section SE1. For example, the calculator 500b may calculate the predicted relative velocity when the object T reaches the body of the vehicle 100, based on the rate of change or the amount of change of the relative velocity of the object T positioned at each of the relative distances in the specified section SE1.

Here, the calculator 500b may determine that the predicted relative velocity is predictable when the relative velocity of the object T is detected in all of the relative distances including, for example, "1 m", "2 m", "3 m", "4 m", and "5 m" in the specified section SE1. In contrast, the calculator 500b may determine that an error has occurred when the relative velocity of the object T is not detected in one or more of the relative distances "1 m", "2 m", "3 m", "4 m", and "5 m" in the specified section SE1. At this time, the calculator 500b may determine that the predicted relative velocity is unpredictable, based on the relative velocity of the object T positioned in the specified section SE1.

When determining that the predicted relative velocity is unpredictable, based on the relative velocity of the object T positioned in the specified section SE1, the calculator 500b may calculate the predicted relative velocity of the object T in the detection dead area R1, based on the relative velocity of the object T positioned in the non-specified section SE2. For example, the calculator 500b may calculate the predicted relative velocity when the object T reaches the body of the vehicle 100, based on the rate of change or the amount of change of the relative velocity of the object T positioned at each of the relative distances in the non-specified section SE2.

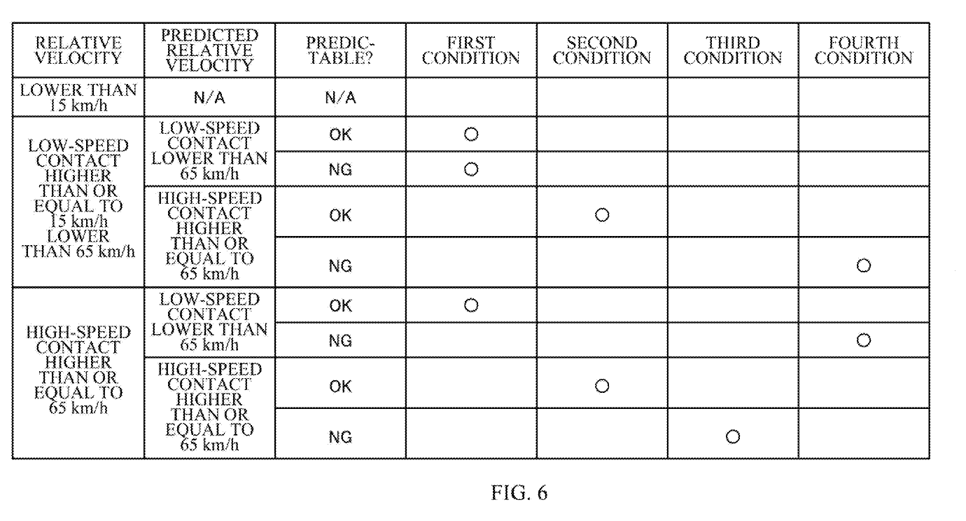

FIG. 6 is a table describing a method of setting the condition for the activation of the airbag 400 according to the present example embodiment. As illustrated in FIG. 6, in the present example embodiment, the control processor 500c may set the condition for the activation of the airbag 400 in accordance with the relative velocity of the object T, the predicted relative velocity, and whether the predicted relative velocity is predictable in the specified section SE1. In FIG. 6, whether the predicted relative velocity is predictable in the specified section SE1 is expressed as "predictable?". Additionally, a case where the predicted relative velocity is predictable in the specified section SE1 is expressed as "OK", and a case where the predicted relative velocity is unpredictable in the specified section SE1 is expressed as "NG".

As illustrated in FIG. 6, when the relative velocity of the object T is higher than or equal to 15 km/h and lower than 65 km/h (the predetermined velocity), the predicted relative velocity is predictable in the specified section SE1, and the predicted relative velocity of the object T is lower than the predetermined velocity, the control processor 500c may set the first condition as the condition for the activation of the airbag 400. Note that, the relative velocity of the object T may be, for example, the relative velocity of the object T acquired by the obtainer 500a immediately before the object T reaches the detection dead area R1. In the example illustrated in FIG. 5, when the relative distance between the body of the vehicle 100 and the object T is less than 1 m and the object T reaches the detection dead area R1, the relative velocity of the object T acquired by the obtainer 500a immediately before the object T reaches the detection dead area R1 may be the relative velocity acquired when the relative distance between the body of the vehicle 100 and the object T is 1 m.

Further, when the relative velocity of the object T is higher than or equal to 15 km/h and lower than 65 km/h (the predetermined velocity), the predicted relative velocity is unpredictable in the specified section SE1, and the predicted relative velocity of the object T predicted in the non-specific section SE2 is lower than the predetermined velocity, the control processor 500c may set the first condition as the condition for the activation of the airbag 400.

Further, when the relative velocity of the object T is higher than or equal to the predetermined velocity, the predicted relative velocity is predictable in the specified section SE1, and the predicted relative velocity of the object T is lower than the predetermined velocity, the control processor 500c may set the first condition as the condition for the activation of the airbag 400.

As described above, when the relative velocity of the object T and the predicted relative velocity are lower than the predetermined velocity, and at the time of the low-speed contact in which the impact of the contact between the vehicle 100 and the object T is relatively small, the control processor 500c may set the condition for the activation of the airbag 400 to the first condition.

The first condition may be, for example, that the detection value detected by the pressure sensor 320 or the acceleration sensor 330 is greater than or equal to the threshold value (the first threshold value). At the time of the low-speed contact, when, for example, the detection value of the pressure sensor 320 becomes greater than or equal to the threshold value, the control processor 500c may determine that the first condition is satisfied and activate the airbag 400. This makes it possible to deploy the airbag 400, based on the detection value of the pressure sensor 320 or the acceleration sensor 330 at the time of the low-speed contact, and thus helps to protect the occupant from the impact of the contact.

In the present example embodiment, when the relative velocity of the object T is higher than or equal to 0 km/h and lower than 15 km/h, the control processor 500c may control the airbag 400 not to be activated. The disclosure is not limited thereto, and in some embodiments, the control processor 500c may control the airbag 400 to be activated, for example, when the relative velocity of the object T is higher than or equal to 0 km/h and lower than 15 km/h.

As illustrated in FIG. 6, when the relative velocity of the object T is higher than or equal to 15 km/h and lower than 65 km/h (the predetermined velocity), the predicted relative velocity is predictable in the specified section SE1, and the predicted relative velocity of the object T is higher than or equal to the predetermined velocity, the control processor 500c may set the second condition as the condition for the activation of the airbag 400.

When the relative velocity of the object T is higher than or equal to the predetermined velocity, the predicted relative velocity is predictable in the specified section SE1, and the predicted relative velocity of the object T is higher than or equal to the predetermined velocity, the control processor 500c may set the second condition as the condition for the activation of the airbag 400.

As described above, in the case of the high-speed contact in which, regardless of the relative velocity of the object T, the predicted relative velocity is higher than or equal to the predetermined velocity, and the impact of the contact between the vehicle 100 and the object T is larger than that in the case of the low-speed contact, the control processor 500c may set the condition for the activation of the airbag 400 to the second condition.

The second condition may be, for example, that the touch sensor 310 shifts from the OFF state to the ON state. If the object T comes into contact with the door on the side of the vehicle 100, the touch sensor 310 may first be shifted from the OFF state to the ON state, based on the contact between the object T and the door. Thereafter, the door may be crushed by the object T, causing the detection value of the pressure sensor 320 or the acceleration sensor 330 to become greater than or equal to the threshold value. It is therefore possible to deploy the airbag 400 earlier by activating the airbag 400, based on the touch sensor 310 compared with a case where the airbag 400 is activated based on the pressure sensor 320 or the acceleration sensor 330.

Therefore, when the touch sensor 310 is shifted to the ON state at the time of the high-speed contact in which the object T comes into contact with the vehicle 100 at a higher speed than at the time of the low-speed contact, the control processor 500c may determine that the second condition is satisfied and activate the airbag 400. This makes it possible to accelerate the deployment timing of the airbag 400 compared with the case where the airbag 400 is deployed based on the detection value of the pressure sensor 320 or the acceleration sensor 330, and thus helps to protect the occupant from the impact of the contact upon the high-speed contact.

Further, as illustrated in FIG. 6, when the relative velocity of the object T is higher than or equal to the predetermined velocity, the predicted relative velocity is unpredictable in the specified section SE1, and the predicted relative velocity of the object T predicted in the non-specific section SE2 is higher than or equal to the predetermined velocity, the control processor 500c may set the third condition as the condition for the activation of the airbag 400.

As described above, when the relative velocity of the object T is unobtainable in the specified section SE1 due to an error, it is difficult to predict the relative velocity of the object T positioned in the detection dead area R1 with high accuracy. However, by using the relative velocity of the object T positioned in the non-specified section SE2 instead of the specified section SE1, it is possible to predict the approximate relative velocity of the object T positioned in the detection dead area R1. Therefore, when the relative velocity of the object T is higher than or equal to the predetermined velocity and the predicted relative velocity predicted in the non-specified section SE2 is higher than or equal to the predetermined velocity, the control processor 500c may predict that it is the high-speed contact in which the impact of the contact between the vehicle 100 and the object T is larger than that in the low-speed contact. In this case, the control processor 500c may set the condition for the activation of the airbag 400 to the third condition.

The third condition may be, for example, that the touch sensor 310 is shifted from the OFF state to the ON state, and that the detection value detected by the pressure sensor 320 or the acceleration sensor 330 is greater than or equal to a lower limit value (a second threshold value smaller than the first threshold value). If the object T comes into contact with the door on the side of the vehicle 100, the touch sensor 310 may first be shifted from the OFF state to the ON state, based on the contact between the object T and the door. Thereafter, the door may be crushed by the object T, causing the pressure sensor 320 or the acceleration sensor 330 to react. Accordingly, the detection value may become greater than or equal to the lower limit value (the second threshold value). It is therefore possible to deploy the airbag 400 earlier by activating the airbag 400, based on the pressure sensor 320 or the acceleration sensor 330 in accordance with the third condition compared with a case where the airbag 400 is activated based on the pressure sensor 320 or the acceleration sensor 330 in accordance with the first condition.

Therefore, when the touch sensor 310 is in the ON state and the detection value detected by the pressure sensor 320 or the acceleration sensor 330 becomes greater than or equal to the lower limit value at the time of the high-speed contact in which the object T is predicted to come into contact with the vehicle 100 at a higher speed than at the time of the low-speed contact, the control processor 500c may determine that the third condition is satisfied and activate the airbag 400. As a result, at the time of the high-speed contact in which the object T is predicted to come into contact with the vehicle 100 at a higher speed than at the time of the low-speed contact, based on the relative velocity of the object T in the non-specified section SE2, it is possible to accelerate the deployment timing of the airbag 400 compared with the case where the airbag 400 is deployed in accordance with the first condition. This helps to protect the occupant from the impact of the contact upon the high-speed contact.

As illustrated in FIG. 6, when the relative velocity of the object T is higher than or equal to 15 km/h and lower than 65 km/h (the predetermined velocity), the predicted relative velocity is unpredictable in the specified section SE1, and the predicted relative velocity of the object T predicted in the non-specific section SE2 is higher than or equal to the predetermined velocity, the control processor 500c may set the fourth condition as the condition for the activation of the airbag 400.

When the relative velocity of the object T is higher than or equal to the predetermined velocity, the predicted relative velocity is unpredictable in the specified section SE1, and the predicted relative velocity of the object T predicted in the non-specific section SE2 is lower than the predetermined velocity, the control processor 500c may set the fourth condition as the condition for the activation of the airbag 400.

As described above, when the relative velocity of the object T is lower than the predetermined velocity and the predicted relative velocity predicted in the non-specified section SE2 is higher than or equal to the predetermined velocity, the control processor 500c may predict that the relative velocity of the object T is close to the predetermined velocity and that the impact of the contact between the vehicle 100 and the object T corresponds to that at the time of the high-speed contact slightly larger than that at the time of the low-speed contact. In this case, the control processor 500c may set the condition for the activation of the airbag 400 to the fourth condition.

Further, when the relative velocity of the object T is higher than or equal to the predetermined velocity and the predicted relative velocity predicted in the non-specified section SE2 is lower than the predetermined velocity, the control processor 500c may predict that the relative velocity of the object T is close to the predetermined velocity and that it is the high-speed contact in which the impact of the contact between the vehicle 100 and the object T is slightly larger than that at the time of the low-speed contact. In this case, the control processor 500c may set the condition for the activation of the airbag 400 to the fourth condition.

The fourth condition may be, for example, that the touch sensor 310 is shifted from the OFF state to the ON state and that the detection value detected by the pressure sensor 320 or the acceleration sensor 330 is greater than or equal to an intermediate value (a third threshold value between the first threshold value and the second threshold value). If the object T comes into contact with the door on the side of the vehicle 100, the touch sensor 310 may first be shifted from the OFF state to the ON state, based on the contact between the object T and the door. Thereafter, the door may be crushed by the object T, causing the pressure sensor 320 or the acceleration sensor 330 to react. Accordingly, the detection value may become greater than or equal to the intermediate value (the third threshold). It is therefore possible to deploy the airbag 400 earlier by activating the airbag 400, based on the pressure sensor 320 or the acceleration sensor 330 in accordance with the fourth condition compared with a case where the airbag 400 is activated based on the pressure sensor 320 or the acceleration sensor 330 in accordance with the first condition.

Therefore, when the touch sensor 310 is in the ON state and the detection value detected by the pressure sensor 320 or the acceleration sensor 330 becomes greater than or equal to the intermediate value at the time of the high-speed contact in which the object T is predicted to come into contact with the vehicle 100 at a slightly higher speed than at the time of the low-speed contact, the control processor 500c may determine that the fourth condition is satisfied and activate the airbag 400. Accordingly, in a case where the predicted relative velocity of the object T is close to the predetermined velocity, it is possible to accelerate the deployment timing of the airbag 400 compared with a case where the airbag 400 is deployed in accordance with the first condition. This helps to protect the occupant from the impact of the contact upon the high-speed contact.

As described above, according to the present example embodiment, the control processor 500c changes the condition for the activation of the airbag 400 in accordance with the relative velocity acquired by the object data obtainer 200. Accordingly, it is possible to change the deployment timing of the airbag 400 in accordance with the relative velocity of the object T, and to deploy the airbag 400 at the appropriate timing upon the high-speed contact in which the object T comes into contact with the vehicle 100 at a higher speed than at the time of the low-speed contact.

In some embodiments, the calculator 500b may determine whether the predicted relative velocity of the object T when the object T reaches the body of the vehicle 100 is predictable in the specified section SE1 in which the relative distance between the body of the vehicle 100 and the object T is in a range from 1 m (a first distance) to 5 m (a second distance). Thereafter, when the predicted relative velocity is predictable in the specified section SE1, the calculator 500b may predict the predicted relative velocity. Further, the control processor 500c may change the condition for the activation of the airbag 400 in accordance with the relative velocity of the object T and the predicted relative velocity. Accordingly, it is possible to predict the predicted relative velocity of the object T in the detection dead area R1 of the object data obtainer 200, and to change the deployment timing of the airbag 400 in consideration of the predicted relative velocity. This helps to appropriately control the deployment timing of the airbag 400.

In some embodiments, the condition for the activation of the airbag 400 may include the first condition and the second condition. The first condition may be that the detection value detected by the pressure sensor 320 or the acceleration sensor 330 is greater than or equal to the first threshold value. The second condition may be a condition that causes the timing at which the activation of the airbag 400 is started to be earlier than the timing based on the first condition. Additionally, the second condition may be that the touch sensor 310 is shifted from the OFF state to the ON state. The control processor 500c may change the condition from the first condition to the second condition when the predicted relative velocity predicted in the specified section SE1 is higher than or equal to 65 km/h (the predetermined velocity). This makes it possible to accelerate the deployment timing of the airbag 400 compared with the case where the airbag 400 is deployed based on the detection value of the pressure sensor 320 or the acceleration sensor 330, and thus helps to protect the occupant from the impact of the contact upon the high-speed contact.

In some embodiments, the condition for the activation of the airbag 400 may include the third condition. The third condition may be a condition that causes the timing at which the activation of the airbag 400 is started to be earlier than the timing based on the first condition. Additionally, the third condition may be that the touch sensor 310 is in the ON state and the detection value detected by the pressure sensor 320 or the acceleration sensor 330 is greater than or equal to the second threshold value smaller than the first threshold value. The control processor 500c may change the condition from the first condition to the third condition when the relative velocity acquired by the object data obtainer 200 is higher than or equal to 65 km/h (the predetermined velocity), the predicted relative velocity is unpredictable in the specified section SE1, and the predicted relative velocity when the object T reaches the body of the vehicle 100 predicted in the non-specified section SE2 is higher than or equal to 65 km/h (the predetermined velocity). The non-specified section SE2 is a section in which the relative distance is greater than the range of the relative distance of the specified section SE1. Accordingly, even when the relative velocity of the object T is unpredictable in the specified section SE1 due to an event such as an error, when it is predicted that there is a high possibility that the object T comes into contact with the vehicle 100 at a high speed of 65 km/h (the predetermined velocity) or more, it is possible to appropriately control the deployment timing of the airbag 400 to make the deployment timing as early as possible compared with the case of the low-speed contact.

In some embodiments, the condition for the activation of the airbag 400 may include the fourth condition. The fourth condition may be a condition that causes the timing at which the activation of the airbag 400 is started to be earlier than the timing based on the first condition. The fourth condition may be that the touch sensor 310 is in the ON state and the detection value detected by the pressure sensor 320 or the acceleration sensor 330 is greater than or equal to the third threshold value between the first threshold value and the second threshold value smaller than the first threshold value. The control processor 500c may change the condition from the first condition to the fourth condition when the relative velocity acquired by the object data obtainer 200 is lower than 65 km/h (the predetermined velocity), the predicted relative velocity is unpredictable in the specified section SE1, and the predicted relative velocity when the object T reaches the body of the vehicle 100 predicted in the non-specified section SE2 is higher than or equal to 65 km/h (the predetermined velocity). The non-specified section SE2 is a section in which the relative distance is greater than the range of the relative distance of the specified section SE1. Alternatively, the control processor 500c may change the condition from the first condition to the fourth condition when the relative velocity acquired by the object data obtainer 200 is higher than or equal to 65 km/h (the predetermined velocity), the predicted relative velocity is unpredictable in the specified section SE1, and the predicted relative velocity when the object T reaches the body of the vehicle 100 predicted in the non-specified section SE2 is lower than 65 km/h (the predetermined velocity). Accordingly, even when the relative velocity of the object T is unpredictable in the specified section SE1 due to an event such as an error, when it is predicted that there is a high possibility that the object T comes into contact with the vehicle 100 at or near 65 km/h (the predetermined velocity), it is possible to appropriately control the deployment timing of the airbag 400 to make the deployment timing slightly earlier compared with the case of the low-speed contact.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms "a", "an", and "the" include, especially in the context of the claims, are to be construed to cover both the singular and the plural, unless otherwise indicated herein or clearly contradicted by context.

Throughout this specification and the appended claims, unless the context requires otherwise, the terms "comprise", "include", "have", and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term "substantially", "approximately", "about", and its variants having a similar meaning thereto are defined as being largely but not necessarily wholly what is specified as understood by one of ordinary skill in the art.

The term "disposed on/ provided on/ formed on" and its variants having a similar meaning thereto as used herein refer to elements disposed directly in contact with each other or indirectly by having intervening structures therebetween.

A vehicle according to at least one embodiment of the disclosure makes it possible to deploy an airbag at appropriate timing upon contact of the vehicle.

As used herein, the term "collision" may be used interchangeably with the term "contact".

The control apparatus 500 illustrated in FIGS. 2 to 4 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control apparatus 500 illustrated in FIGS. 2 to 4. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control apparatus 500 illustrated in FIGS. 2 to 4.

1. A vehicle comprising:
an airbag provided in a body of the vehicle;
an object data obtainer comprising a radar and a camera, and configured to perform acquisition of a relative velocity of an object with respect to the body of the vehicle;
a contact obtainer comprising a sensor and configured to perform acquisition of data indicating that the object and the body of the vehicle have come into contact with each other; and
a control apparatus configured to control the airbag, based on a result of the acquisition of the object data obtainer and a result of the acquisition of the contact obtainer, wherein
the control apparatus comprises one or more processors and one or more memories coupled to the one or more processors,
the one or more processors being configured to
perform activation of the airbag in accordance with the result of the acquisition of the contact obtainer, and
change a condition for the activation of the airbag in accordance with the relative velocity acquired by the object data obtainer.

2. The vehicle according to claim 1, wherein
the object data obtainer is configured to perform acquisition of a relative distance between the body of the vehicle and the object, and
the one or more processors are configured to
determine whether a predicted relative velocity of the object with respect to the body of the vehicle when the object reaches the body of the vehicle is predictable in a specified section, the specified section being a section in which the relative distance is in a range from a first distance to a second distance,
when the predicted relative velocity is predictable in the specified section, predict the predicted relative velocity, and
change the condition for the activation of the airbag in accordance with the relative velocity and the predicted relative velocity.

3. The vehicle according to claim 2, wherein
the contact obtainer comprises:
a pressure sensor or an acceleration sensor provided at a door on the body of the vehicle; and
a touch sensor provided on an outer surface of the door,
the condition for the activation of the airbag comprises
a first condition in which a detection value detected by the pressure sensor or the acceleration sensor is greater than or equal to a first threshold value, and
a second condition in which the touch sensor is shifted to an ON state, the second condition being a condition that causes timing at which the activation of the airbag is started to be earlier than the timing based on the first condition, and
the one or more processors are configured to, when the predicted relative velocity predicted in the specified section is higher than or equal to a predetermined velocity, change the condition from the first condition to the second condition.

4. The vehicle according to claim 2, wherein
the contact obtainer comprises:
a pressure sensor or an acceleration sensor provided at a door on the body of the vehicle; and
a touch sensor provided on an outer surface of the door,
the condition for the activation of the airbag comprises
a first condition in which a detection value detected by the pressure sensor or the acceleration sensor is greater than or equal to a first threshold value, and
a third condition in which the touch sensor is shifted to an ON state, and the detection value detected by the pressure sensor or the acceleration sensor is greater than or equal to a second threshold value smaller than the first threshold value, the third condition being a condition that causes timing at which the activation of the airbag is started to be earlier than the timing based on the first condition, and
the one or more processors are configured to
when: the relative velocity acquired by the object data obtainer is higher than or equal to a predetermined velocity; the predicted relative velocity is unpredictable in the specified section; and the predicted relative velocity when the object reaches the body of the vehicle predicted in a non-specified section is higher than or equal to the predetermined velocity,
change the condition from the first condition to the third condition, the non-specified section being a section in which the relative distance is greater than the range of the relative distance of the specified section.

5. The vehicle according to claim 2, wherein
the contact obtainer comprises:
a pressure sensor or an acceleration sensor provided at a door on the body of the vehicle; and
a touch sensor provided on an outer surface of the door,
the condition for the activation of the airbag comprises
a first condition in which a detection value detected by the pressure sensor or the acceleration sensor is greater than or equal to a first threshold value, and
a fourth condition in which the touch sensor is shifted to an ON state, and the detection value detected by the pressure sensor or the acceleration sensor is greater than or equal to a third threshold value between the first threshold value and a second threshold value smaller than the first threshold value, the fourth condition being a condition that causes timing at which the activation of the airbag is started to be earlier than the timing based on the first condition, and
the one or more processors are configured to,
when: the relative velocity acquired by the object data obtainer is lower than a predetermined velocity; the predicted relative velocity is unpredictable in the specified section; and the predicted relative velocity when the object reaches the body of the vehicle predicted in a non-specified section is higher than or equal to the predetermined velocity, change the condition from the first condition to the fourth condition, the non-specified section being a section in which the relative distance is greater than the range of the relative distance of the specified section, or
when: the relative velocity acquired by the object data obtainer is higher than or equal to the predetermined velocity; the predicted relative velocity is unpredictable in the specified section; and the predicted relative velocity when the object reaches the body of the vehicle predicted in the non-specified section is lower than the predetermined velocity,
change the condition from the first condition to the fourth condition.
